(19) United States
(12) Patent Application Publication
(10) Pub. No.: US 2005/0227554 A1
(43) Pub. Date: Oct. 13, 2005

(54) Paddle blade, shaft and grip

(76) Inventors: John Hevesi, Aurora (CA); Steve Horvath, Oxbridge (CA)

Correspondence Address: PATTON BOGGS LLP, 2550 M STREET NW, WASHINGTON, DC, 20037-1350, US

(21) Appl. No.: 10/822,159

(22) Filed: Apr. 12, 2004

(51) Int. Cl. B26D 3/16

(52) U.S. Cl. 440/101

(57) ABSTRACT

A paddle includes a shaft, a blade, and a grip. The blade includes a skeleton to reinforce the blade and an outer surface secured to the skeleton. The skeleton and the outer surface are made of the same and/or different injection molded materials and/or of composite materials. The blade is attached to the shaft. The shaft includes a surface profile, and the grip includes a complimentary surface profile to engage the surface profile of the shaft to removably interlock the grip to the shaft.

### FIELD OF THE INVENTION

The present invention relates to paddle blades, shafts and grips.

### DESCRIPTION OF BACKGROUND INFORMATION

Known kayak paddle blades having injection molded plastic utilize a single plastic component in their construction. Accordingly, manufacturers of these blades rely on a single component for the strength of the blades and, thus, the blades tend to be heavy and cumbersome in their design.

### BRIEF DESCRIPTION OF THE DRAWINGS In the drawings, like reference numerals represent similar parts of the illustrated embodiments of the present invention throughout the several views and wherein:

FIGS. 1, 4 and 5 depict an embodiment of a blade;

FIGS. 2 and 3 depict an embodiment of a skeleton;

FIGS. 6, 7 and 8 depicts an embodiment of a shaft; and

FIG. 9 depicts an embodiment of grip.

### DETAILED DESCRIPTION

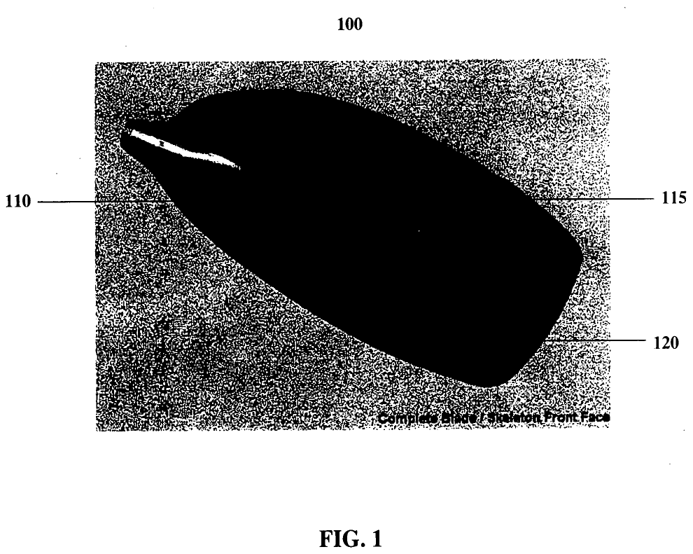

One embodiment of a blade 100 (see, for example, FIG. 1) utilizes, for example, separate injection molded components (e.g., two or more) that may be locked together. The blade may include a skeleton 110 and an outer surface 120. The skeleton may be stiff to reinforce the blade, while the outer surface may be strong to provide abrasion resistance. The blade may thus be configured to be lighter, stronger and/or of higher performance than those currently available.

The skeleton 110 (e.g., a stiff plastic skeleton) may be used as a component of the blade. The skeleton may include one or more ribs 115. The skeleton (e.g., the one or more ribs) may be used to reinforce the blade longitudinally and/or laterally. The skeleton may also be injection molded and the injection molded material may be plastic and/or a composite material. The skeleton may provide the blade with an overall stiffness, for example, similar to that of high performance composite blades having a higher price.

The outer surface 120 may include a plastic and/or a polycarbonate (e.g., a clear tinted polycarbonate), for example, for the skin and/or body of the blade. A polycarbonate skin may provide the blade with a tough outer surface and an appealing look. The skeleton may include a stiffer material (e.g., stiffer plastic) than included in the outer surface to provide added stiffness.

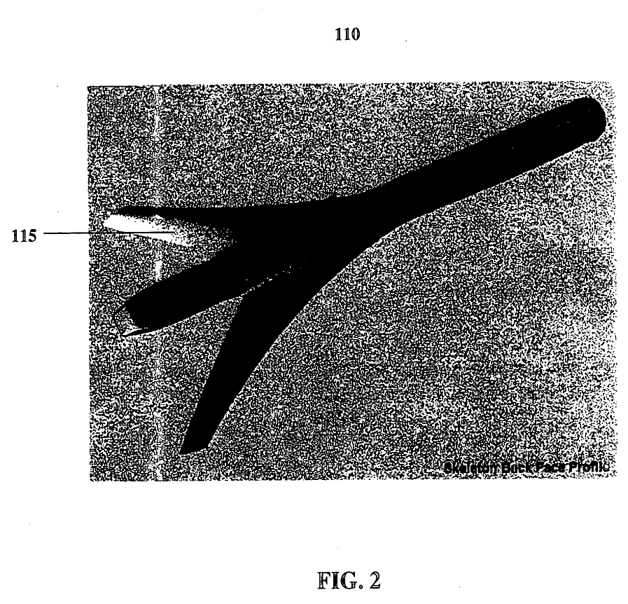

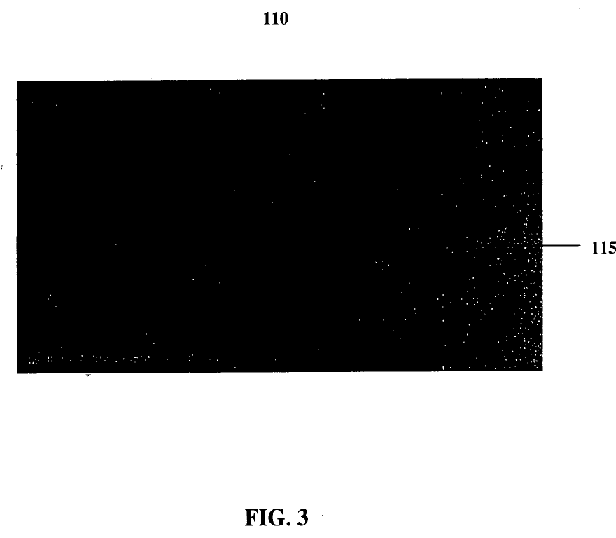

The outer surface 120 may be molded (e.g., injection molded) over the skeleton to form the blade. The skeletal reinforcement may be configured, for example, so that material (e.g., plastic) flow over its surface is not impeded by the structure itself. The cross sections of a skeletal rib may be configured as an airfoil or “wing” shaped (see, for example, FIGS. 2 and 3). The cross sections allow, for example, molten plastic to travel over its surface without turbulence. The lack of turbulence minimizes the possibility of trapping air within the resulting molded part and permits the use of clear plastic to be injection molded onto the skeleton without the presence of large voids being formed within the part.

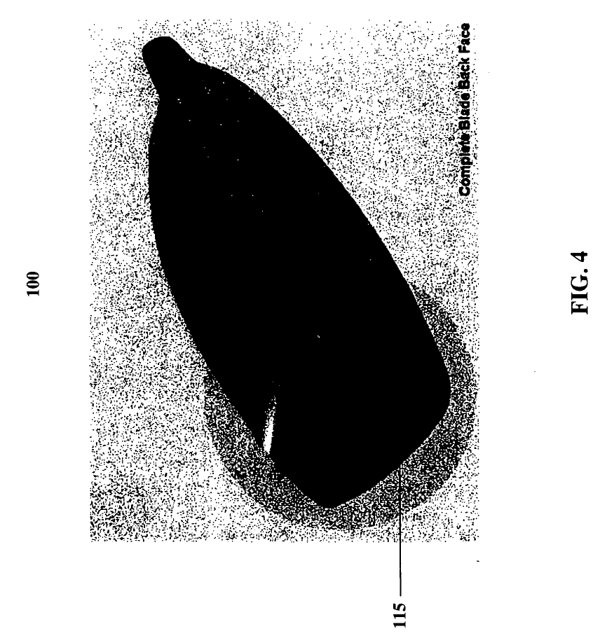

The skeletal reinforcement may be configured to provide support not only to the tip of the blade, but also in three distinct directions (see, for example, FIG. 4). FIG. 4 illustrates a multi-pronged (e.g., three-pronged) skeleton that provides structural support to the longitudinal end of the blade and/or the outer tips of the blade. The skeleton, for example, may provide the largest amount of structural support to the outer end of the blade with the least amount of material. This will enable the blade to have the lowest mass for a required strength.

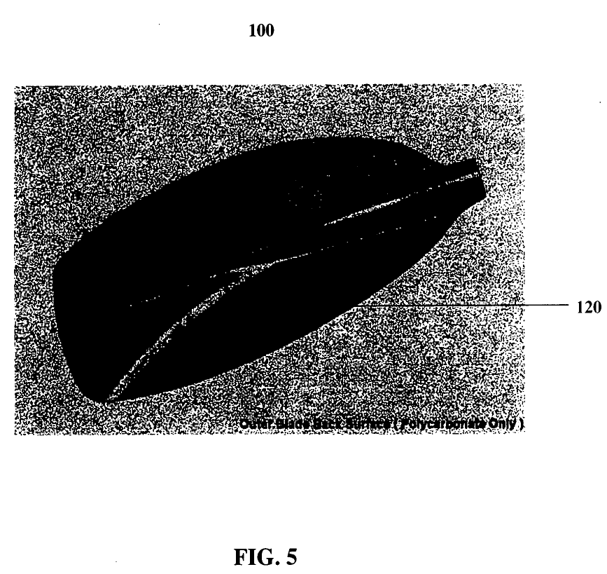

The outer surface may be molded over the skeleton, for example, in a secondary molding operation that secures the skeletal reinforcement within (e.g., entirely within) a shell (e.g., plastic outer shell). The shell provides the blade an outer structure, in whole or in part, and is configured to mold over the skeleton with a uniform thickness. The outer shell of the blade interacts with the environment, for example, while paddling and is the component of the blade that takes the abrasion abuse associated with paddle sports. As such, the outer shell may be molded from a high impact plastic such as, for example, polycarbonate that can provide resistance to impact damage while allowing a unique cosmetic appearance (see, for example, FIG. 5).

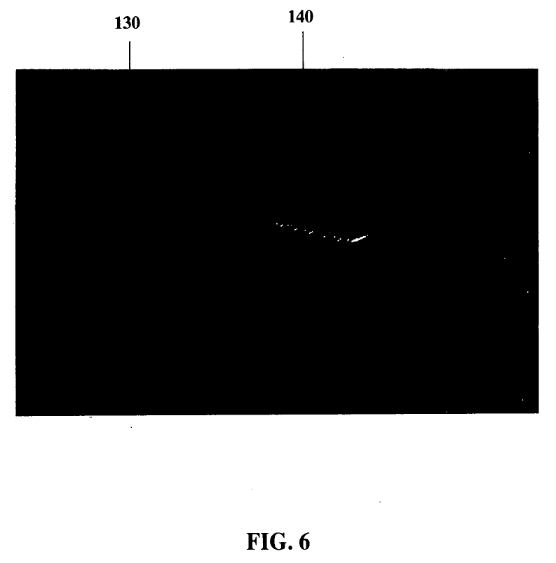

A paddle includes the blade and, also, include a shaft 130 (see, for example, FIG. 6). The paddle may include a composite shaft that is molded and/or bent to be ergonomically configured. The shaft may include a grip 140 (e.g., molded grip and/or handlebar grip). The shaft and the grip are illustrated to be configured such that the orientation and location of the grip on the shaft allow for the correct ergonomic position of the paddler's hands on the shaft. The grip may be injection molded separately and/or attached to the paddle shaft in a separate operation.

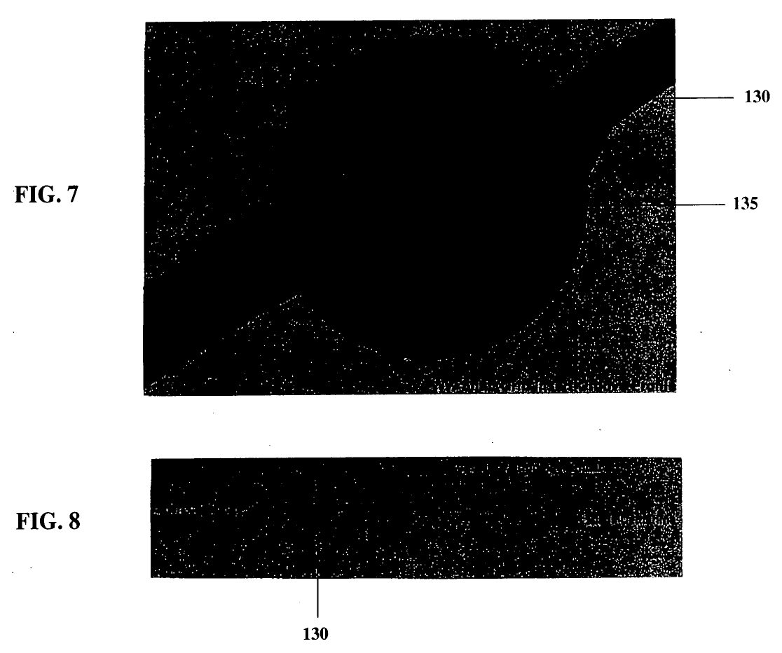

The shaft may include a surface profile 135, for example, along a gripping section configured to accept a complimentary gripping component (see, for example, FIG. 7). The surface profile may lock the grip into position, for example, along the shaft axis in a longitudinal direction and/or latitudinal (e.g., arcuate) direction. The surface profile is configured, for example, so as to prevent the movement of the grip in one or more planes and/or directions once installed.

The shaft (e.g., bar, pole, etc.) may include one or more bends such as, for example, the three bends as illustrated in FIG. 8. The bends may be configured so as to provide a proper ergonomic alignment and placement of the grip, relative the user. An offset angle of the gripping section of the shaft may be between about 8 and 17 degrees (or more or less) from a centerline of the shaft. A centerline of the blade may be oriented, for example, so as to bisect the center of the gripping section.

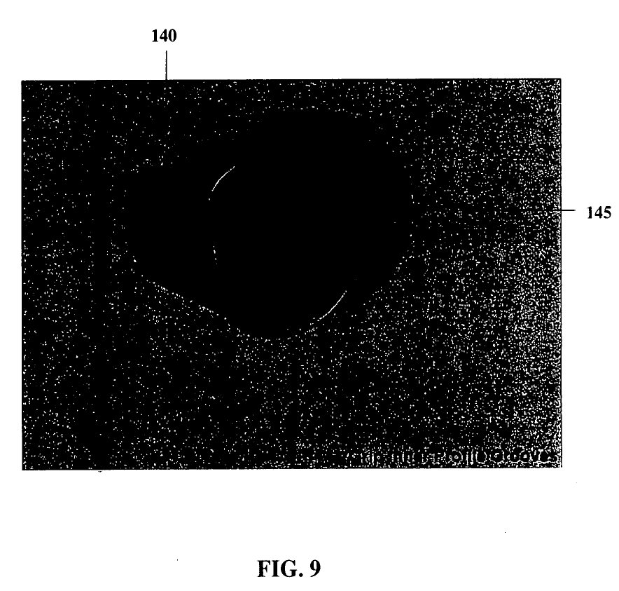

An internal surface 145 of the grip (see, for example, FIG. 9) may be configured to lock into position at the corresponding location on the shaft (see, for example, FIGS. 6-7). The outer surface of the grip may be configured, for example, with an oval profile to accommodate the users hand in a comfortable manner. The grip may be offered in a plurality of distinct sizes to accommodate users with small and large hands. The interlocking surfaces 135 and 145 allow the interchangeability of grip sizes by the end user.

The shaft may also include one of (i) a groove (e.g., slot) and (ii) a projection (e.g., lug), and the grip may include the other one of (i) the groove and (ii) the projection to engage the one of (i) the groove and (ii) the projection of the shaft to secure the grip to the shaft.

A blade may include a multi-component injection molded design. A stiff internal skeleton may provide reinforcement, while a strong outer surface may provide abrasion resistance. A paddle (e.g., a kayak paddle) may include the blade and also a shaft (e.g., a composite bent shaft) with a gripping area configured to accommodate a grip with a complimentary gripping area. The grip may be located on the shaft in a predetermined orientation and location. Other structures such as, for example, a handlebar (e.g., a bicycle handlebar), a ski pole, a shovel, etc. may include the shaft and/or the grip.

The foregoing presentation of the described embodiments (e.g., of a paddle, blade, shaft and/or grip) is provided to enable any person skilled in the art to make or use the present invention. Various modifications to these embodiments are possible, and the generic principles presented herein may be applied to other embodiments as well. As such, the present invention is not intended to be limited to the embodiments shown above, and/or any particular configuration of structure but rather is to be accorded the widest scope consistent with the principles and novel features disclosed in any fashion herein.

1. A paddle comprising:
a shaft;
a blade; and
a grip,
wherein the blade includes (1) a skeleton to reinforce the blade both longitudinally and laterally and (2) an outer surface secured to the skeleton,
wherein the skeleton and the outer surface are made of different and/or the same injection molded materials and/or composite materials,
wherein the blade is attached to the shaft, and
wherein the shaft includes a surface profile, and the grip includes a complimentary surface profile to engage the surface profile of the shaft to removably interlock the grip to the shaft.

2. The paddle of claim 1, wherein the skeleton includes a plurality of ribs.

3. The paddle of claim 2, wherein the ribs are wing-shaped.

4. The paddle of claim 2, wherein the injection molded material of the skeleton includes plastic.

5. The paddle of claim 2, wherein the injection molded material of the outer surface includes polycarbonate.

6. The paddle of claim 1, wherein the shaft is shaped to provide an ergonomic placement and alignment of the grip for a hand of a paddler.

7. The paddle of claim 1, wherein the shaft is bent such that (1) a centerline of a first portion of the shaft is offset from a centerline of a second portion of the shaft by at least one of (i) more than 8 degrees and (ii) less than 17 degrees, and (2) a centerline of a third portion of the shaft bisect the center portion of the first portion of the shaft.

8. The paddle of claim 7,
wherein the complimentary surface profile of the grip engages the surface profile of the shaft at the first portion of the shaft, and
wherein the blade is attached to the shaft at the third portion of the shaft.

9. The paddle of claim 1, wherein the shaft includes a molded composite.

10. The paddle of claim 1, wherein the complimentary surface profile of the grip engages the surface profile of the shaft to also locate the grip, relative to the shaft, in a predetermined orientation and position.

11. A system comprising:
a shaft; and
a handlebar grip,
wherein the shaft includes a surface profile, and the grip includes a complimentary surface profile to engage the surface profile of the shaft to removably interlock the grip to the shaft in a predetermined orientation and position.

12. The system of claim 11, wherein the shaft is ergonomically shaped.

13. The system of claim 11, wherein the shaft is bent such that (1) a centerline of a first portion of the shaft is offset from a centerline of a second portion of the shaft by (i) about more than 8 degrees and (ii) about less than 17 degrees.

14. The system of claim 13, wherein the complimentary surface profile of the grip engages the surface profile of the shaft at the first portion of the shaft.

15. The system of claim 11, wherein the shaft includes a molded composite.

16. The system of claim 11, wherein the shaft includes a bar and/or a pole.

17. A system comprising:
a shaft; and
a handlebar grip,
wherein the shaft includes one of (i) a groove and (ii) a projection, and the grip includes the other one of (i) the groove and (ii) the projection to engage the one of (i) the groove and (ii) the projection of the shaft to secure the grip to the shaft.

18. A paddle blade comprising:
a skeleton; and
an outer surface,
wherein the skeleton reinforces the paddle blade longitudinally and/or laterally,
wherein the outer surface is secured to the skeleton, and
wherein the skeleton and the outer surface are made of different injection molded materials and/or composite materials.

19. The paddle blade of claim 18, wherein the skeleton includes a plurality of ribs.

20. The paddle blade of claim 18, wherein the ribs are wing-shaped.

21. The paddle blade of claim 18, wherein the injection molded material of the skeleton is made of plastic.

22. The paddle blade of claim 18, wherein the injection molded material of the outer surface includes polycarbonate.
